(19) United States
(12) Patent Application Publication
(10) Pub. No.: US 2024/0391294 A1
(43) Pub. Date: Nov. 28, 2024

(54) METHOD OF DETECTION AND MITIGATION OF OUTSIDE HEAT EXCHANGER ICING FOR AUTOMOTIVE HEAT PUMP SYSTEM

(71) Applicant: Ford Global Technologies, LLC, Dearborn, MI (US)

(72) Inventors: Jeffrey Paul Brown, Farmington Hills, MI (US); Westin Pusey, Brownstown, MI (US); James C. Rollinson, Ypsilanti, MI (US); Aaron James Vandiver, West Bloomfield Township, MI (US)

(73) Assignee: Ford Global Technologies, LLC, Dearborn, MI (US)

(21) Appl. No.: 18/796,517

(22) Filed: Aug. 7, 2024

Related U.S. Application Data
(63) Continuation-in-part of application No. 17/740,593, filed on May 10, 2022.

(51) Int. Cl. B60H 1/00

(52) U.S. Cl. CPC B60H 1/00878; B60H 1/00278; B60H 1/00671; B60H 2001/00961

(57) ABSTRACT

A method of detecting and mitigating icing of an outside heat exchanger in an electric vehicle including a heat pump. Various sources of heat may be utilized to de-ice an outside heat exchanger of the heat pump. The sources of heat may include one or more of vehicle electronics, a high voltage (“HV”) battery, and an HV coolant heater. Pre-defined criteria may be utilized to determine the actions to be taken to de-ice the outside heat exchanger and/or to prevent icing of the outside heat exchanger.

### CROSS-REFERENCE TO RELATED APPLICATION

This application is a continuation-in-part of U.S. patent application Ser. No. 17/740,593, filed on May 10, 2022, entitled “VAPOR INJECTION HEAT PUMP,” the entire disclosure of which is incorporated herein by reference.

### FIELD OF THE DISCLOSURE

The present disclosure generally relates to vehicle heat exchangers, and more particularly to a method to mitigate icing of an outside heat exchanger.

### BACKGROUND OF THE DISCLOSURE

Various types of heat pumps have been developed for use in motor vehicles. The heat pumps may include an outside heat exchanger.

### SUMMARY OF THE DISCLOSURE

An aspect of the present disclosure is a method of de-icing an outside heat exchanger of a heat pump of an electrically powered vehicle having a high voltage (traction) battery that supplies electrical power to one or more electric motors that move the vehicle, wherein the heat pump is configured to heat a cabin of the electrically powered vehicle. The method includes implementing a first de-icing mode if an ambient air temperature is at or above a first predefined temperature that is greater than freezing. The first de-icing mode includes turning off the heat pump and using coolant from a high voltage heater to heat the cabin and/or to heat the high voltage battery. The method further includes implementing a second de-icing mode if the high voltage battery can accept cooling according to predefined criteria. The second de-icing mode includes chilling the high voltage battery and utilizing heat from the high voltage battery to heat the outside heat exchanger by causing the coolant that has been heated by the high voltage battery to flow through the outside heat exchanger. The method further includes implementing a third de-icing mode if the high voltage battery cannot accept cooling according to predefined criteria, and if the high voltage battery temperature is greater than a second predefined temperature that is above freezing. The third de-icing mode includes turning the heat pump off, utilizing a high voltage coolant heater to heat the cabin of the electrically powered vehicle, and circulating coolant through the high voltage battery and the outside heat exchanger in a combined fluid circuit to heat the outside heat exchanger. The method further includes implementing a fourth de-icing mode if the high voltage battery cannot accept cooling according to predefined criteria, and if the high voltage battery temperature is not greater than the second predefined temperature. The fourth de-icing mode includes turning the heat pump off, using the high voltage coolant heater to heat the cabin, and circulating coolant between power electronics of the vehicle, a water-cooled condenser of the heat pump, and the outside heat exchanger to thereby heat the outside heat exchanger.
The first pre-defined temperature may be 3° C.
The electrically powered vehicle may include an electric fan and grill shutters that can be actuated to control air flow over the outside heat exchanger, and the first de-icing mode may include opening the grill shutters and actuating the electric fan to increase flow of ambient air over the outside heat exchanger.
After the outside heat exchanger has been de-iced utilizing the first, second, third, or fourth de-icing mode, the method may include opening the grill shutters and actuating the electric fan to dissipate water droplets on the outside heat exchanger.
The method may include determining if icing of the outside heat exchanger is imminent during cabin heating. If icing of the outside heat exchanger is imminent, prior to implementing any of the first, second, third, and fourth de-icing modes, the method may include opening shutters of the outside heat exchanger and activating an electric fan to increase flow of ambient air over the outside heat exchanger, and exiting vapor injection operation of the heat pump.
The first mode may include increasing air flow over the outside heat exchanger by opening grill shutters of the outside heat exchanger and actuating an electric fan of the outside heat exchanger.
The second mode may include reducing air flow over the outside heat exchanger by closing grill shutters of the outside heat exchanger and actuating an electric fan of the outside heat exchanger.
The third mode may include reducing air flow over the outside heat exchanger by closing grill shutters of the outside heat exchanger and actuating an electric fan of the outside heat exchanger.
The second predefined temperature above freezing may be 3° C.-10° C.

Another aspect of the present disclosure is a method of de-icing an outside heat exchanger of a heat pump of an electrically powered vehicle having a high voltage battery, wherein the heat pump is configured to heat a cabin of the electrically powered vehicle. The method includes implementing a first de-icing mode if conditions satisfying first predefined criteria are detected. The first de-icing mode includes reducing heat pump output and using heat from a high voltage coolant heater to heat the cabin and/or to heat the high voltage battery. The method includes implementing a second de-icing mode if the high voltage battery can accept cooling according to predefined criteria. The second de-icing mode includes utilizing heat from the high voltage battery to heat the outside heat exchanger. The method includes implementing a third de-icing mode if the high voltage battery cannot accept cooling according to predefined criteria, and if the high voltage battery temperature is greater than a second predefined temperature that is above freezing. The third de-icing mode includes reducing heat pump output, utilizing a high voltage coolant heater to heat the cabin of the electrically powered vehicle, and circulating coolant through the high voltage battery and the outside heat exchanger in a combined fluid circuit to heat the outside heat exchanger. The method includes implementing a fourth de-icing mode if the criteria for the first, second, and third de-icing modes are not satisfied. The fourth de-icing mode includes turning the heat pump off, using high voltage battery coolant to heat the cabin, and circulating coolant between power electronics of the vehicle, a water-cooled condenser of the heat pump, and the outside heat exchanger to thereby heat the outside heat exchanger.
The first pre-defined criteria may comprise a selected ambient temperature that is above freezing.
The second de-icing mode may include causing coolant that has been heated by the high voltage battery to flow through the outside heat exchanger.
The fourth de-icing mode may, optionally, not be implemented unless the high voltage battery cannot accept cooling according to pre-defined criteria and if the high voltage battery temperature is not greater than the second predefined temperature.
The first de-icing mode may include turning off the heat pump.
The third de-icing mode may include turning off the heat pump.
After implementing the fourth de-icing mode, if a circuit cooling temperature is below a pre-defined threshold, the method may include causing coolant to bypass the outside heat exchanger, and heating the coolant circulating through the power electronics of the vehicle, and the water-cooled condenser of the heat pump using motor electronics waste heat, and/or operating the power electronics of the vehicle in a lossy mode.
After implementing the fourth de-icing mode, if a circuit cooling temperature is above a pre-defined threshold, the method may include causing coolant to flow through the outside heat exchange to de-ice the outside heat exchanger.

The electrically powered vehicle may include an electric fan and grill shutters that can be actuated to control air flow over the outside heat exchanger, and the first de-icing mode may include opening the grill shutters and actuating the electric fan to increase flow of ambient air over the outside heat exchanger.
After the outside heat exchanger has been de-iced utilizing the first, second, third, or fourth de-icing mode, the grill shutters may be opened, and the electric fan may be actuated to dissipate water droplets on the outside heat exchanger.
The method may include determining if icing of the outside heat exchanger is imminent during cabin heating. If icing of the outside heat exchanger is imminent, prior to implementing any of the first, second, third, and fourth de-icing modes, the method may include opening shutters of the outside heat exchanger and activating an electric fan to increase flow of ambient air over the outside heat exchanger, and exiting vapor injection operation of the heat pump.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a schematic showing heat pump heat flow in a heat mode;

FIG. 2 is a flow chart showing a process for determining if icing of an outside heat exchanger is imminent; and

FIG. 3 is a flow chart showing a process of mitigating outside heat exchanger icing according to an aspect of the present disclosure.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

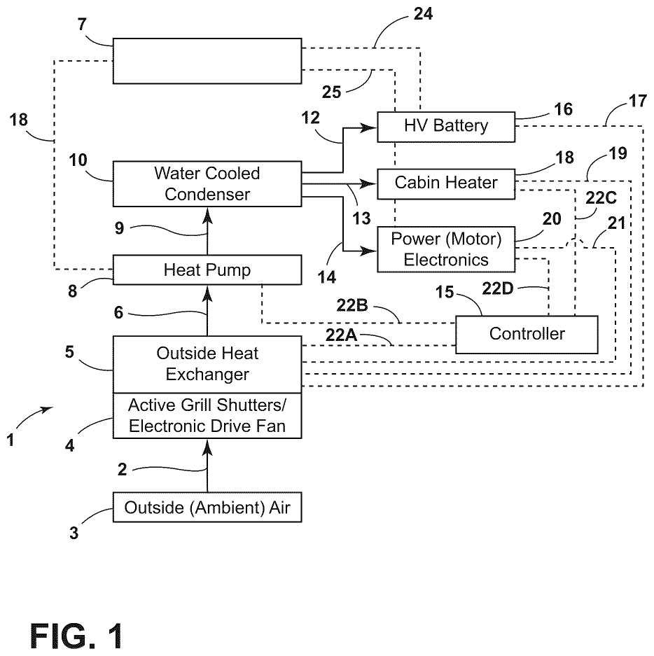

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a heat pump. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the terms “or” and “and/or,” when used in a list of two or more items, means that any one of the listed items can be employed by itself, or any combination of two or more of the listed items can be employed. For example, if a composition or device is described as containing or comprising components A, B, or C, the composition or device can contain (include) A alone; B alone; C alone; A and B in combination; A and C in combination; B and C in combination; or A, B, and C in combination. If a composition or device is described as containing or comprising components A or B or C, the composition or device can contain (include) A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” “including” or any other variation thereof, are intended to cover a non-exclusive inclusion, such that a process, method, article, or apparatus that includes or comprises a list of elements does not include only those elements but may include other elements not expressly listed or inherent to such process, method, article, or apparatus. An element preceded by “comprises . . . a” or “includes . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

In general, Battery Electric Vehicles (BEVs) do not have internal combustion engines, and therefore have an alternative way to provide heat utilizing a heat pump system and/or an electric heater. An air conditioner cycle or refrigerant cycle has a cold heat exchanger and a hot heat exchanger. A conventional air conditioner uses the cold heat exchanger to cool passengers, while the hot heat exchanger is exposed to outside air. For BEVs, a refrigerant cycle can be used as a conventional air conditioner system to cool the cabin and the battery. The refrigerant cycle may also comprise a heat pump system that uses the hot side to heat the cabin, defrost the windshield, and heat the HV battery while the cold outside heat exchanger can be exposed to outside (ambient) air. If the cold (outside) heat exchanger is exposed to moisture where frost or ice starts to form on the outside heat exchanger, preventive actions may be necessary. These preventive actions may include warming up the outside heat exchanger to thaw the frost or ice to liquid, which may be followed by blowing off (removing) liquid water from the outside heat exchanger.

Icing of outside heat exchangers may create issues with regards to compressor operation and system heat rejection capability (reduced heat output). When an outside heat exchanger is de-iced, normal heating functions of the system cannot occur, which may result in use of lower efficiency electrical heaters. Delayed de-ice (without attributes/loss of performance) and optimized de-ice (time and source of heat) may provide a better passenger experience.

In addition to preventing excess ice/frost on the outside heat exchanger, the present disclosure provides a way to prevent excessive thermocycling of the outside heat exchanger. The present disclosure may include determining how quickly the outside heat exchanger is freezing and may also include maintaining output to meet heating demand. A method according to an aspect of the present disclosure reduces or eliminates ice/frost buildup on the outside heat exchanger without cycling too frequently or at too large a temperature delta “shock” level in a manner that could degrade components of the system.

The present disclosure also provides de-icing utilizing an optimal heat source. As discussed in more detail below, the system may be configured to determine if an acceptable form of heat is available, and what source of heat is optimal for the purpose of de-icing of the outside heat exchanger based on operating conditions. In general, the outside heat exchanger may be thawed quickly under some conditions (coldest ambient air temperature, but with lowest total levels of moisture on the outside heat exchanger). However, if mild ambient conditions exist whereby road splash or rain or slush may freeze while HV battery chillers and/or LTR (Low Temperature Radiator) are at sub-zero temperature operation (i.e., a situation in which heat may be more easily “trapped” in coolant whereby de-icing can be delayed without reducing passenger comfort). Example sources of heat are powertrain/electronics (including “lossy” versions if the vehicle is equipped with these components), HV battery, and HV coolant heater.

With reference to FIG. 1, a system 1 according to an aspect of the disclosure includes an outside heat exchanger 5 including active grill shutters and an electronic drive fan 4. In use, outside air 3 may flow over the outside heat exchanger 5 to provide heat transfer, and the active grill shutters and electronic drive fan 4 may be utilized to control flow of outside air 3. The arrow 2 generally indicates heat flow from outside (ambient) air 3 to the outside heat exchanger 5.

The system 1 further includes a heat pump 8 that may be actuated to provide heat 9 to a water-cooled condenser 10. Heat from the water-cooled condenser 10 may be transferred to a high voltage battery 16, a cabin heater 18, and power (motor) electronics 20 as shown by arrows 12, 13, and 14. In general, the heat flow corresponding to arrows 6, 9, 12, 13, and 14 may be accomplished utilizing one or more coolant circuits as described in Brown et al., U.S. Pat. No. 11,906,213, issued on Feb. 20, 2024, and/or Ragazzi, U.S. Pat. No. 10,190,812, issued on Jan. 29, 2019, the entire contents of each are hereby incorporated by reference in their entireties. The system 1 may optionally include one or more coolant circuits 17, 19, and 21 that permit transfer of heat from HV battery 16, cabin heater 18, and power electronics 20, respectively, to the outside heat exchanger 5. Coolant circuits 17, 19, and 21 may comprise conduits for fluid in the form of loops that cause coolant to flow through heat exchangers of the HV battery 16, cabin heater 18, and power electronics 20, and through the outside heat exchanger 5 to thereby selectively transfer heat from HV battery 16 and/or cabin heater 18 and/or power electronics 20 to the outside heat exchanger 5. Controller 15 may be configured to selectively actuate pumps and/or valves (not shown) of one of more of the coolant circuits 17 and/or 19 and/or 21 in any combination as required to control coolant flow to transfer heat to (or from) outside heat exchanger 5 based on operating conditions. System 1 may also include a low temperature outside radiator 7 that is exposed to ambient air. Low temperature outside radiator 7 may comprise an air to liquid (coolant) heat exchanger. Low temperature radiator 7 may be operably connected to heat pump 8 by a coolant circuit 18. If the heat pump 8 is off, the low temperature radiator 7 may be used to cool HV battery 16 and/or power electronics 20 via coolant circuits 24 and 25, respectively. Coolant circuits 18, 24 and 25 may comprise conduits, valves, and one or more pumps (not shown) that may be selectively actuated by controller 15 to cause coolant to flow through the Coolant circuits 18, 24 and 25 as required based on operating conditions and the method of the present disclosure. It will be understood the low temperature radiator 7 and coolant circuits 17, 18, 19, 21, 24, and 25 are optional, and system 1 may utilize one or more of the coolant circuits disclosed in the above-identified Patent Applications to provide the heat transfer functions of one or more of circuits 17, 18, 19, 21, 24, and 25. Thus, system 1 may include only one of coolant circuits 17, 18, 19, 21, 24, and 25, or system 1 may include selected ones of the circuits in any combination.

The system I may include a controller 15 that is operably connected to the various components as shown by the dashed lines 22A-22D. It will be understood that controller 15 may comprise one or more individual controllers in the form of hardware and/or software that may be integrated with various vehicle controllers and systems.

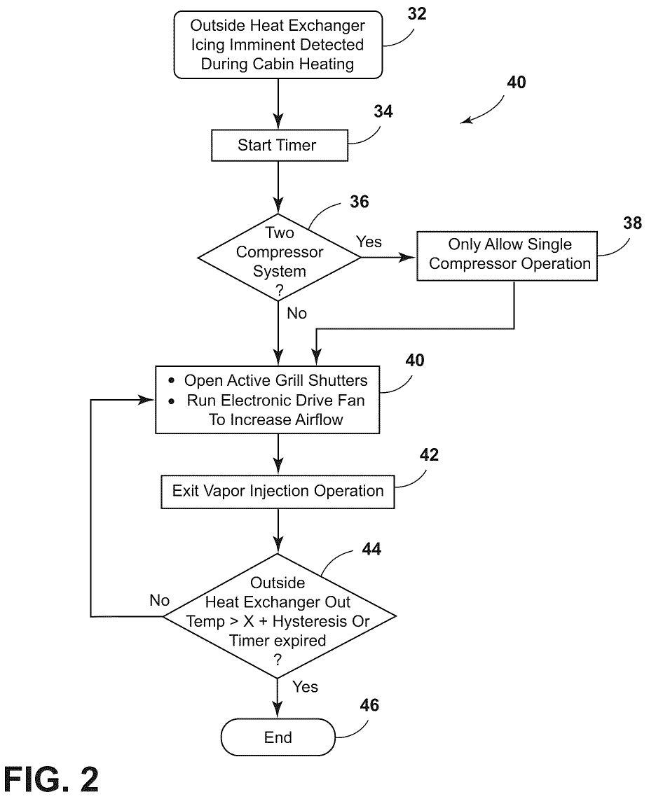

With further reference to FIG. 2, a process 30 may be utilized to detect imminent icing of outside heat exchanger 5 whereby conditions can be monitored to determine if further action is required to prevent icing of outside heat exchanger 5 or de-ice outside heat exchanger 5. At 32, outside heat exchanger icing imminent is detected during cabin heating. Imminent icing and/or icing may be detected by monitoring radiator outlet temperature (i.e. the temperature of coolant exiting low temperature radiator 7) during heat pump operation with relation to outside air temperature. The threshold for icing imminent may be different than the threshold for icing detected. Icing detected occurs with a very large delta between ambient air temperature and radiator outlet temperature. Icing imminent detection occurs with a slightly smaller delta between ambient and LTR (radiator 7) out temperature when compared to icing detected. After imminent icing is detected at 32, a timer is started at 34. At step 36, if the system 1 is a two compressor system, the process only allows a single compressor to operate as shown at 38. At 40, active grill shutters of outside heat exchanger 5 are opened, and the electronic drive fan is actuated to increase air flow over the outside heat exchanger 5. At 42, vapor injection operation may be exited. At 44, the process determines if the outside heat exchanger 5 outside temperature is greater than X degrees Celsius +hysteresis or if the timer has expired (e.g. outside air temperature is greater than a calibratable threshold). It will be understood that hysteresis generally refers to a temperature difference (e.g. 1, 2, 3, 4, 5, 10 degrees Celsius) between “on” and “off” to prevent excessive cycling. If “NO” at 44, the processor returns to step 40. If “YES” at 44, the process ends at 46.

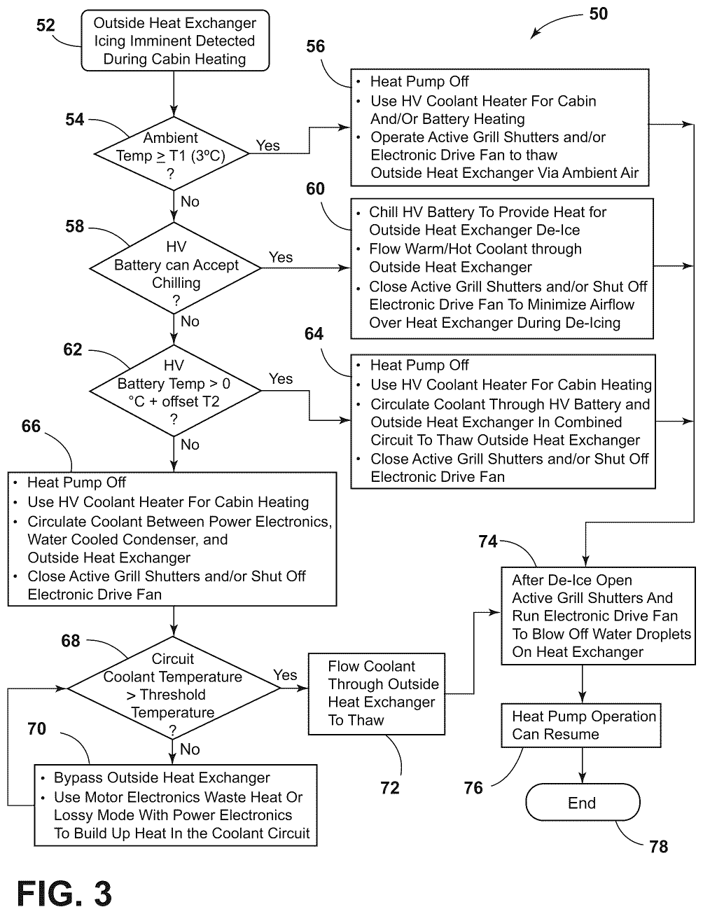

With further reference to FIG. 3, a process 54 de-icing outside heat exchanger 5 may include implementing actions for modes 56, 60, 64, 66, 70, and 72 based on detected operating conditions 54, 58, 62, and 68. At 52, process 50 begins if imminent icing of outside heat exchanger 5 is detected during cabin heating. At 54, if the ambient temperature is greater than or equal to “T1” (e.g., 3° C.), the process implements a first mode or group of actions 56 may include one or more of 1) during heat pump OFF and/or 2) using HV coolant heater for cabin and/or battery heating and/or 3) operating active grill shutters and/or electronic drive fan to thaw outside heat exchanger 5 via ambient air 3. It will be understood that the heat pump does not necessarily need to be completely turned off, and the heat pump may be operated at a reduced level.

If the ambient temperature is not greater than or equal to T1 at 54, at 58 the process determines if the HV battery 16 can accept chilling according to predefined criteria. The predefined criteria may include battery temperature and battery state of charge. A lookup table using high voltage battery state of charge and high voltage battery temperature as inputs could be used to arbitrated whether battery cooling is acceptable or not. Additional control inputs/factors could include ambient air temperature, and battery power usage. If the HV battery 16 can accept chilling at 58, the process proceeds to a second mode or group of actions 60, which may include one or more of 1) chilling the HV battery to provide heat for de-icing of outside heat exchanger and/or 2) causing warm or hot coolant to flow through the outside heat exchanger 5 and/or 3) closing the active grill shutters and/or shutting off the electronic drive fan to minimize flow of ambient air over outside heat exchanger 5 during de-icing.

If the HV battery cannot accept chilling at 58, the process continues to 62. At 62, the system (e.g., controller 15) determines if a temperature HV battery 16 is greater than 0° C. plus an offset “T2” wherein T2 is a calibratable temperature (T2 refers to HV battery temperature). If the HV battery temperature is greater than 0° C. plus an offset T2 at 62, the third actions or mode 64 is implemented. The third mode 64 may include one or more of 1) turning the heat pump OFF (or reducing heat pump output) and/or 2) using HV coolant heater for cabin heating and/or 3) circulating coolant through the HV battery 16 and outside heat exchanger 5 in combined circuit to thaw outside heat exchanger 5 and/or 4) closing active grill shutters and/or shutting off the electronic drive fan. The combined circuit may combine HV battery and a low temperature radiator 7 into the same continuous coolant circuit 24 to allow coolant to flow between HV battery 16 and low temperature radiator 7. In general, “combined circuit” refers to circulating within a coolant loop, or coolant flow path. The circuit is the loop or flow path the coolant flows through in a certain mode of operation. Having HV battery 16 and a low temperature radiator 7 in the same circuit 24 provides coolant circulation between HV battery 16 and low temperatures radiator 7.

If the HV battery temperature is not greater than 0° C. plus an offset T2 at step 62, the process continues to a fourth mode or group of actions 66, which may include one or more of: 1) turning the heat pump OFF (or reducing heat pump output) and/or: 2) using HV coolant heater for cabin heating and/or: 3) circulating coolant between power electronics, a water-cooled condenser and outside heat exchanger 5 and/or: 4) closing active grill shutters and/or shutting off the electronic drive fan.

Following step 66, at step 68 the process (e.g., controller 15) determines if the circuit cooling temperature is greater than a threshold temperature. The threshold temperature may comprise a calibratable temperature threshold that is calibrated to the specific vehicle application. This threshold ensures the coolant that is used to thaw the outside heat exchanger 5 is sufficiently warm to do so. This threshold temperature value is above and offset from 0° C. Bypassing the low temperature radiator 7 or outside heat exchanger 5 redirects the coolant flow around the heat exchangers, thus bypassing it (e.g. using a bypass valve). Bypassing the outside heat exchanger 5 prevents heat transfer with the ambient and the low temperature radiator 7 while building up some heat in the coolant via lossy mode etc. When it is sufficiently warm, coolant flows through the outside heat exchanger 5 to de-ice it.

If the circuit coolant temperature is not greater than the threshold temperature at step 68, at step 70, one or more actions are taken. The actions may include: 1) bypassing the outside heat exchanger and/or: 2) using motor electronics waste heat or “lossy mode” with power electronics to build up heat in the coolant circuit. Lossy mode generally refers to the use of the motor electronics to generate additional heat. In the case of an electric motor controller for a battery powered electric vehicle the electric motor can be operated in such a way to generate heat at the component. This heat can be transferred to the coolant flowing through the motor electronics 20 (FIG. 1) and then passed to the outside heat exchanger 5 for the purpose of de-icing.

If the circuit coolant temperature is above a threshold temperature at step 68, at step 72 coolant is flowed through the outside heat exchanger 5 to thaw the outside heat exchanger 5.

After de-icing at steps 56, 60, 64, or 72, the process continues to step 74, and the active grill shutters are opened, and the electronic drive fan is actuated to blow water droplets off heat exchanger 5. As shown at step 76, operation of heat pump 8 can then resume, and process 50 ends at 78.

The outside heat exchanger 5 can collect frost or ice from moisture contained on road surface or with in ambient air, which can block air flow or, in extreme conditions, degrade the heat exchanger 5. The present disclosure provides a way to detect and prevent frost from forming on the outside heat exchanger 5 to maintain performance, increase vehicle efficiency, and increase durability.

It is to be understood that variations and modifications can be made on the aforementioned structure and methods without departing from the concepts of the present invention, and further it is to be understood that such concepts are intended to be covered by the following claims unless these claims by their language expressly state otherwise.

What is claimed is:

1. A method of de-icing an outside heat exchanger of a heat pump of an electrically powered vehicle having a high voltage battery, wherein the heat pump is configured to heat a cabin of the electrically powered vehicle, the method comprising:
implementing a first de-icing mode if an ambient air temperature is at or above a first predefined temperature that is greater than freezing, wherein the first de-icing mode includes turning off the heat pump and using coolant from a high voltage coolant heater to heat the cabin and/or to heat the high voltage battery;
implementing a second de-icing mode if the high voltage battery can accept cooling according to predefined criteria, wherein the second de-icing mode includes chilling the high voltage battery and utilizing heat from the high voltage battery to heat the outside heat exchanger by causing the coolant that has been heated by the high voltage battery to flow through the outside heat exchanger;
implementing a third de-icing mode if the high voltage battery cannot accept cooling according to predefined criteria, and if the high voltage battery temperature is greater than a second predefined temperature that is above freezing, wherein the third de-icing mode includes turning the heat pump off, utilizing a high voltage coolant heater to heat the cabin of the electrically powered vehicle, and circulating coolant through the high voltage battery and the outside heat exchanger in a combined fluid circuit to heat the outside heat exchanger; and
implementing a fourth de-icing mode if the high voltage battery cannot accept cooling according to predefined criteria and if the high voltage battery temperature is not greater than the second predefined temperature, wherein the fourth de-icing mode includes turning the heat pump off, using high voltage battery coolant to heat the cabin, and circulating coolant between power electronics of the vehicle, a water-cooled condenser of the heat pump, and the outside heat exchanger to thereby heat the outside heat exchanger.

2. The method of claim 1, wherein:
the first pre-defined temperature is 3° C.

3. The method of claim 1, wherein:
the electrically powered vehicle includes an electric fan and grill shutters that can be actuated to control air flow over the outside heat exchanger, and
the first de-icing mode includes opening the grill shutters and actuating the electric fan to increase flow of ambient air over the outside heat exchanger.

4. The method of claim 3, wherein:
after the outside heat exchanger has been de-iced utilizing one or more of the first, second, third, or fourth de-icing modes, opening the grill shutters and actuating the electric fan to dissipate water droplets on the outside heat exchanger.

5. The method of claim 1, wherein:
utilizing predefined criteria to determine if icing of the outside heat exchanger is imminent during cabin heating; and
if icing of the outside heat exchanger is imminent, prior to implementing any of the first, second, third, and fourth de-icing modes, 1) open shutters of the outside heat exchanger and activate an electric fan to increase flow of ambient air over the outside heat exchanger, and 2) exit vapor injection operation of the heat pump.

6. The method of claim 1, wherein:
the first mode includes increasing air flow over the outside heat exchanger by opening grill shutters of the outside heat exchanger and actuating an electric fan of the outside heat exchanger.

7. The method of claim 1, wherein:
the second mode includes reducing air flow over the outside heat exchanger by closing grill shutters of the outside heat exchanger and actuating an electric fan of the outside heat exchanger.

8. The method of claim 1, wherein:
the third mode includes reducing air flow over the outside heat exchanger by closing grill shutters of the outside heat exchanger and actuating an electric fan of the outside heat exchanger.

9. The method of claim 1, wherein:
the second predefined temperature above freezing is 3° C.-10° C.

10. A method of de-icing an outside heat exchanger of a heat pump of an electrically powered vehicle having a high voltage battery, wherein the heat pump is configured to heat a cabin of the electrically powered vehicle, the method comprising:
implementing a first de-icing mode if conditions satisfying a first predefined criteria are detected, wherein the first de-icing mode includes reducing the heat pump output and using heat from a high voltage coolant heater to heat the cabin and/or to heat the high voltage battery;
implementing a second de-icing mode if the high voltage battery can accept cooling according to predefined criteria, wherein the second de-icing mode includes utilizing heat from the high voltage battery to heat the outside heat exchanger;
implementing a third de-icing mode if the high voltage battery cannot accept cooling according to predefined criteria, and if the high voltage battery temperature is greater than a second predefined temperature that is above freezing, wherein the third de-icing mode includes reducing the heat pump output, utilizing a high voltage coolant heater to heat the cabin of the electrically powered vehicle, and circulating coolant through the high voltage battery and the outside heat exchanger in a combined fluid circuit to heat the outside heat exchanger; and
implementing a fourth de-icing mode if the criteria for the first, second, and third de-icing modes is not satisfied, wherein the fourth de-icing mode includes turning the heat pump off, using high voltage battery coolant to heat the cabin, and circulating coolant between power electronics of the vehicle, a water-cooled condenser of the heat pump, and the outside heat exchanger to thereby heat the outside heat exchanger.

11. The method of claim 10, wherein:
the first pre-defined criteria may comprise a selected ambient temperature that is above freezing.

12. The method of claim 10, wherein:
the second de-icing mode includes causing the coolant that has been heated by the high voltage battery to flow through the outside heat exchanger.

13. The method of claim 10, wherein:
the fourth de-icing mode is not implemented unless the high voltage battery cannot accept cooling according to predefined criteria and if the high voltage battery temperature is not greater than the second predefined temperature.

14. The method of claim 10, wherein:
the first de-icing mode includes turning off the heat pump.

15. The method of claim 10, wherein:
the third de-icing mode includes turning off the heat pump.

16. The method of claim 10, including:
after implementing the fourth de-icing mode, if a circuit cooling temperature is below a pre-defined threshold, cause coolant to bypass the outside heat exchanger, and heat the coolant circulating through the power electronics of the vehicle, and the water-cooled condenser of the heat pump using motor electronics waste heat, and/or operating the power electronics of the vehicle in a lossy mode.

17. The method of claim 10, including:
after implementing the fourth de-icing mode, if a circuit cooling temperature is above a pre-defined threshold, cause coolant to flow through the outside heat exchanger to de-ice the outside heat exchanger.

18. The method of claim 10, wherein:
the electrically powered vehicle includes an electric fan and grill shutters that can be actuated to control air flow over the outside heat exchanger; and
the first de-icing mode includes opening the grill shutters and actuating the electric fan to increase flow of ambient air over the outside heat exchanger.

19. The method of claim 10, including:
after the outside heat exchanger has been de-iced utilizing the first, second, third, or fourth de-icing mode, opening the grill shutters and actuating the electric fan to dissipate water droplets on the outside heat exchanger.

20. The method of claim 10, including:
utilizing predefined criteria to determine if icing of the outside heat exchanger is imminent during cabin heating;
if icing of the outside heat exchanger is imminent, prior to implementing any of the first, second, third, and fourth de-icing modes, 1) open the shutters of the outside heat exchanger and activate an electric fan to increase flow of ambient air over the outside heat exchanger, and 2) exit vapor injection operation of the heat pump.
